(19) United States
(12) Patent Application Publication
(10) Pub. No.: US 2010/0016895 A1
(43) Pub. Date: Jan. 21, 2010

(54) PACIFIER

(75) Inventors: Daniella Eisenberg, Savion (IL); Uri Mussaffi, Savion (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: AVTIPUS PATENTS AND INVENTIONS LTD., Moshav Benei Atarot (IL)

(21) Appl. No.: 12/523,729

(22) PCT Filed: Dec. 11, 2007
(86) PCT No.: PCT/IL2007/001525

§ 371 Date: Jul. 19, 2009

(30) Foreign Application Priority Data
Jan. 25, 2007 (IL) 180940

(51) Int. Cl. A61J 17/00

(52) U.S. Cl. 606/234

(57) ABSTRACT

In one aspect, the present invention is directed to a pacifier, comprising: a nipple; a protection cap; and a connection mechanism, for connecting the nipple to the cap, the connection mechanism comprise a springy element wherein in the idle state of the springy mechanism the nipple is entirely protected by the cap from contact with a plane, and in the non-idle state thereof the nipple outstands from the plane, thereby enabling being used by an infant. According to one embodiment the connection mechanism comprises: a cylinder; a sliding plug fitting closely inside the bore of the cylinder; a spring keeping the plug secured to an opening of the cylinder, the nipple being connected to the plug. The springy element may be based on a spring, bellows, an elastic object, and so forth.

### FIELD OF THE INVENTION

The present invention relates to the field of pacifiers.

### BACKGROUND OF THE INVENTION

A pacifier (in North American English), dummy (in British, New Zealand, and Australian English) or soother (in Canadian and Irish English), is a rubber or plastic nipple given to an infant to suck upon.

One of the problems of the use of pacifiers is the fact that upon withdrawing the pacifier from the mouth, the pacifier may fall on the floor and get dirty, which requires substantial rinsing of the pacifier.

A well-known solution to this problem is to use a ribbon for connecting a pacifier to a garment of the infant thereof. The ribbon may be connected to the infant's garment by a clip. This prevents the pacifier from falling to the floor when the infant takes the pacifier out of his or her mouth.

A typical pacifier clip generally consists of a pinch clip glued to the back of a piece of plastic. On the one hand the fact that the ribbon is detachable from the garment thereof keeps the safety of the infant, but on the other hand the fact that the ribbon is detachable from the garment thereof by a relatively-small force causes the pacifier to fall to the floor too often.

Furthermore, when a ribbon comes in contact with the face of an infant, it may cause the infant to scratch the place.

It is therefore an object of the present invention to provide a pacifier that the nipple thereof does not get dirty upon falling to the floor.

Other objects and advantages of the invention will become apparent as the description proceeds.

### SUMMARY OF THE INVENTION

The following embodiments and aspects thereof are described and illustrated in conjunction with systems, tools and methods, which are meant to be merely illustrative, not limiting in scope. In various embodiments, one or more of the above-described problems have been reduced or eliminated, while other embodiments are directed to other advantages or improvements.

In one aspect, the present invention is directed to a pacifier, comprising:

a nipple;

a protection cap; and

a connection mechanism, for connecting the nipple to the cap, the connection mechanism comprises a springy element wherein in the idle state of the springy mechanism the nipple is entirely protected by the cap from contact with a plane, and in the non-idle state thereof the nipple outstands from the plane, thereby enabling being used by an infant.

According to one embodiment the connection mechanism comprises:
a cylinder;
a sliding plug fitting closely inside the bore of the cylinder;
a spring keeping the plug secured to an opening of the cylinder, the nipple being connected to the plug.

The springy element may be based on a spring, bellows, an elastic object, and so forth.

The cap may have aperture(s), for allowing the saliva of an infant to be dispersed.

The nipple having may have elongated profile.

In addition to the exemplary aspects and embodiments described above, further aspects and embodiments will become apparent by reference to the figures and by study of the following description.

### BRIEF DESCRIPTION OF THE DRAWINGS

Exemplary embodiments are illustrated in referenced figures. It is intended that the embodiments and figures disclosed herein be considered illustrative, rather than restrictive. The disclosure, however, both as to organization and method of operation, together with objects, features, and advantages thereof, may best be understood by reference to the following detailed description when read with the accompanying figures, in which:

FIG. 1 is a perspective view which schematically illustrates a pacifier, according to one embodiment of the invention.

FIG. 2 is an exploded view of the parts of the embodiment illustrated in FIG. 1.

FIG. 3 is a sectioned view of the use-state of the embodiment illustrated in FIG. 1.

FIG. 4 is a sectioned view of the idle-state of the embodiment illustrated in FIG. 1.

FIG. 5 is a perspective view which schematically illustrates a pacifier, according to another embodiment of the invention.

FIG. 6 is an exploded view of the parts of the embodiment illustrated in FIG. 5.

FIG. 7 is a sectioned view of the use-state of the embodiment illustrated in FIG. 5.

FIG. 8 is a sectioned view of the idle-state of the embodiment illustrated in FIG. 5.

FIG. 9 illustrates an infant using the pacifier illustrated in FIGS. 1 to 4.

It will be appreciated that for simplicity and clarity of illustration, elements shown in the figures have not necessarily been drawn to scale. For example, the dimensions of some of the elements may be exaggerated relative to other elements for greater clarity. Further, where considered appropriate, reference numerals may be repeated among the figures to indicate corresponding or analogous elements.

### DETAILED DESCRIPTION OF PREFERRED EMBODIMENTS

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail, so as not to obscure the present disclosure.

The pacifier of the present invention comprises a nipple and a protection cap. The nipple is connected to the cap by a connection mechanism. In addition to the role of connecting the nipple to the cap, the connection mechanism has two states:
An idle-state, in which the entire nipple is entirely protected by the cap from contact with a plane; and
A use-state, in which a part of the nipple outstands from that plane, and therefore may be used by an infant.

A springy mechanism has two states: an idle state, wherein no force is applied to the spring, and a non-idle state in which a force is applied to the spring. When no force is applied on the springy mechanism, it turns to its idle state.

Preferably, the connection mechanism is springy, thereby in order to use the nipple, it has to be pushed/pulled out of the space protected by the cap. In case the pacifier goes out of an infant's mouth and falls to the floor, the connection mechanism returns the nipple to its idle state even before the pacifier touches the floor. In the idle state the nipple is entirely protected from contact with the floor.

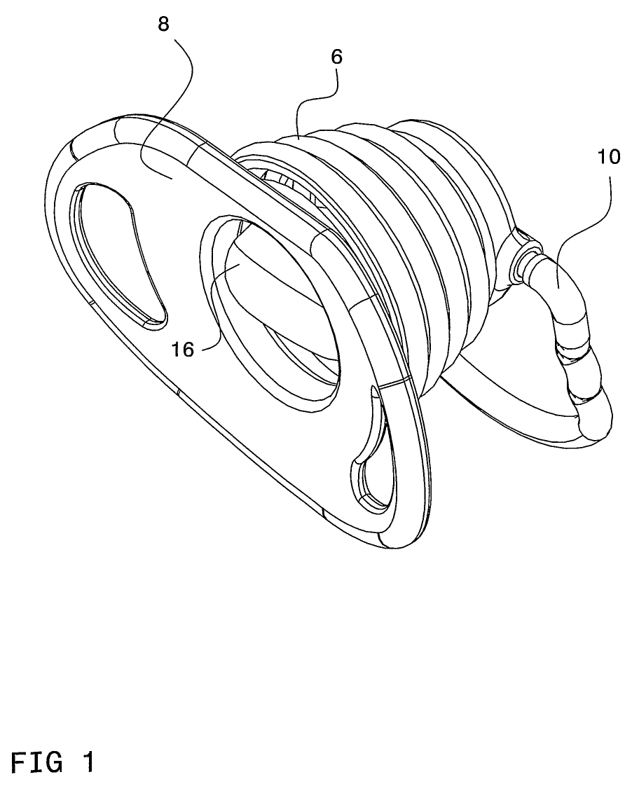

FIG. 1 is a perspective view which schematically illustrates a pacifier, according to one embodiment of the invention.

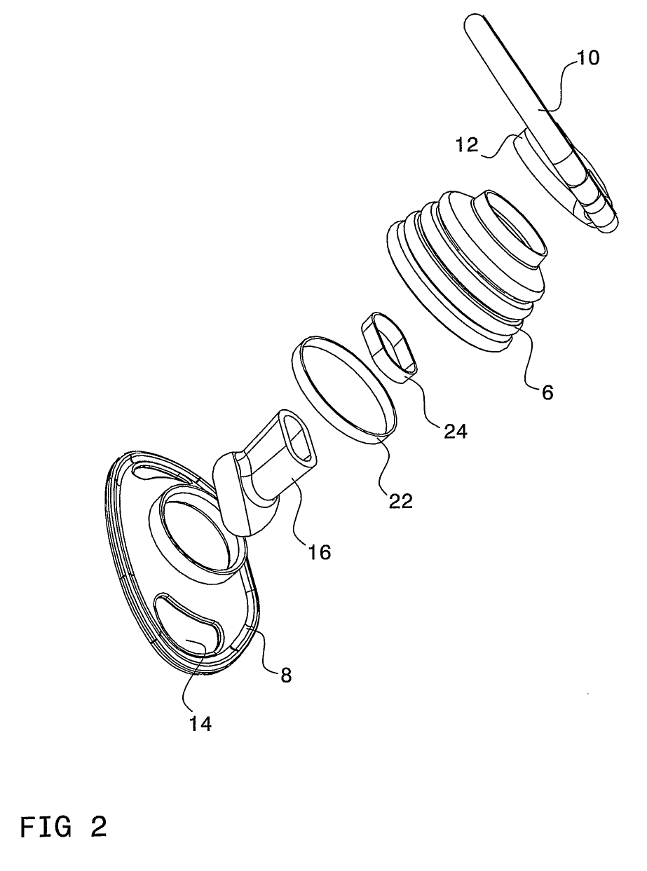

FIG. 2 is an exploded view of the parts thereof.

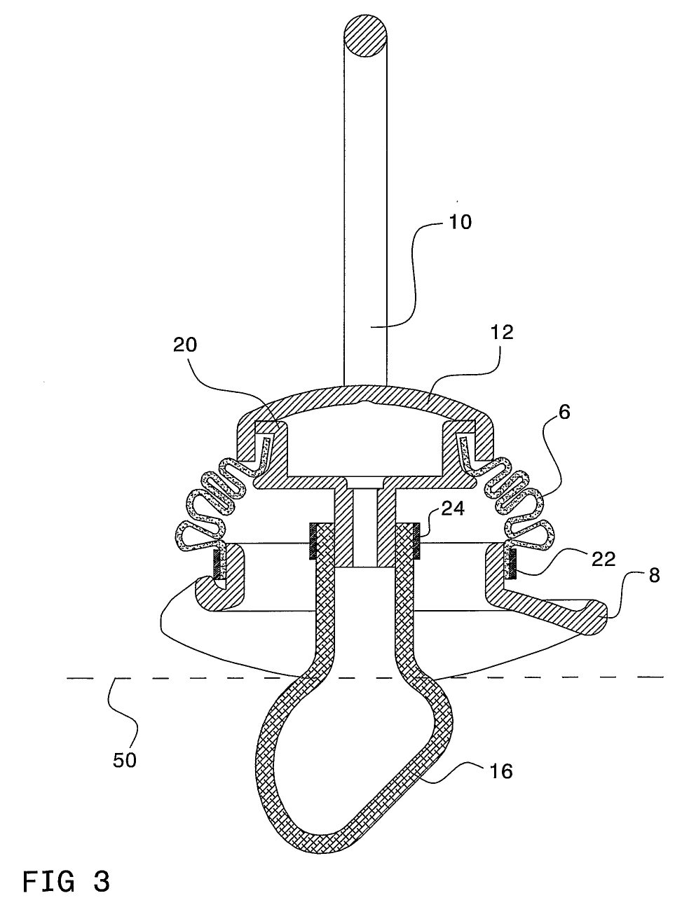

FIG. 3 is a sectioned view of the use-state thereof.

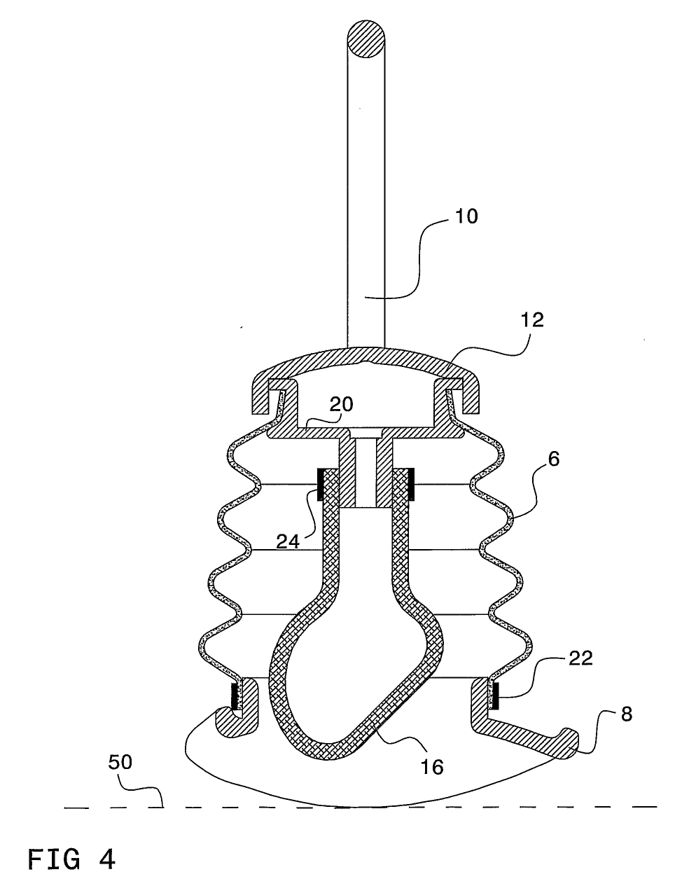

FIG. 4 is a sectioned view of the idle-state thereof.

In these figures the nipple 16 is connected by a connection mechanism to the protection cap 8.

The point that distinguishes the connection mechanism from the prior art is that it comprises a springy element which provides the idle-state and the use-state, as described above.

The springy element of the embodiment illustrates in FIGS. 1 to 4 is the “bellows” 6. The bellows 6 may have a cylindrical form, conical form, and so forth.

The nipple 16 is connected to the coupling 20; the coupling 20 is connected to the bellows 6; and the bellows 6 is connected to the cap 8. Thus, a springy element 6 is coupled in the connection between the nipple 16 and the protection cap 8.

In the idle-state, where the bellows is not folded, the nipple 16 is entirely protected from contact with a plane 50, e.g., the floor. In the use-state, in which the bellows 6 is folded, the nipple is out the plane 50, and therefore may be inserted into an infant's mouth.

In addition, the pacifier illustrated in FIGS. 1 to 4 has a handle 10, which is connected to the coupling 20 by a coupling 18.

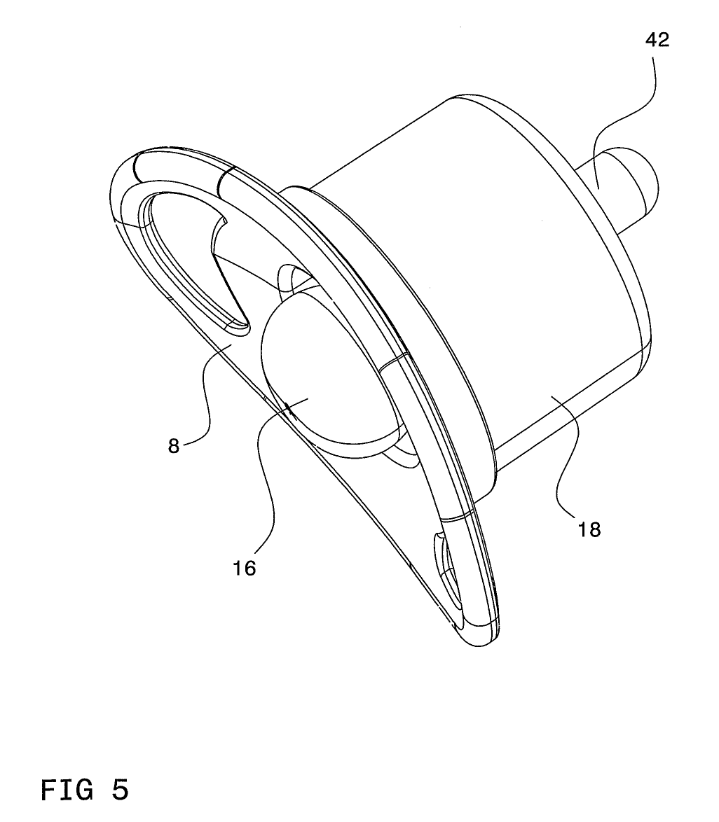

FIG. 5 is a perspective view which schematically illustrates a pacifier, according to another embodiment of the invention.

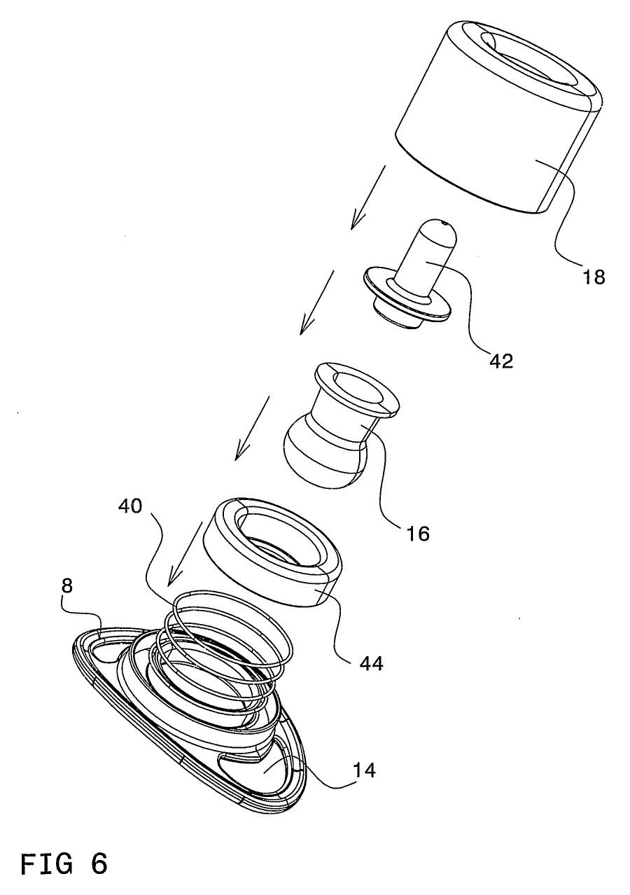

FIG. 6 is an exploded view of the parts thereof.

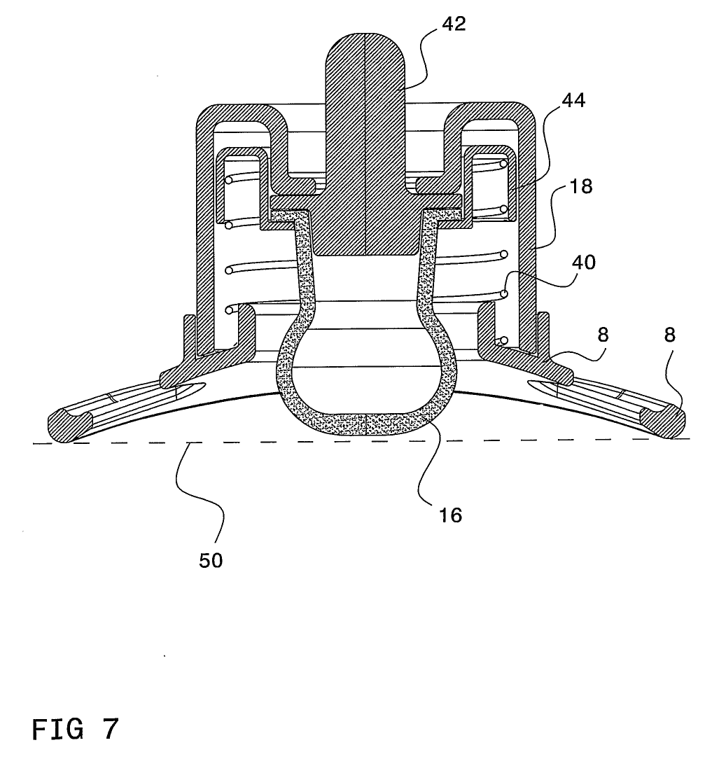

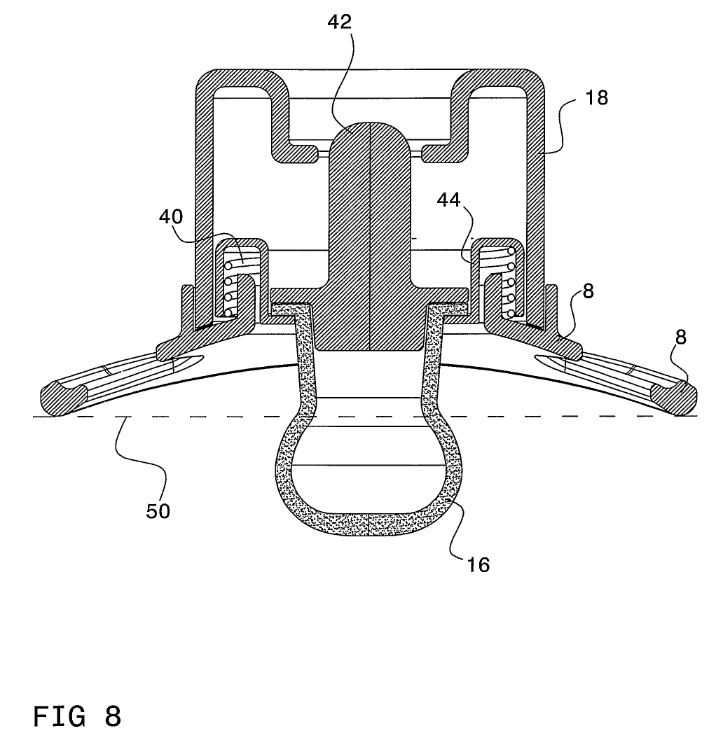

FIG. 7 is a sectioned view of the use-state thereof FIG. 8 is a sectioned view of the idle-state thereof.

In general, a piston is a sliding plug that fits closely inside the bore of a cylinder. The embodiment illustrated in FIGS. 5 to 8 has some similarity with a piston.

In this embodiment element 44 is an analogue to a sliding plug, which slides inside the cylinder 18. A spring 40 keeps the plug 18 tight to the “upper” opening of the cylinder. The nipple 16 is disposed between the edges of plug 44 and the edge of the cylinder 18. Member 42 is used as a rod for pushing the nipple 16 from its idle state to its use state. The cylinder 18 may be connected to the protection cap 8 by a thread (not illustrated), pressure, and so forth.

When an infant looses his hold to the nipple 16, the nipple 16 returns by the power of the spring 40 to its idle state, in which the nipple 16 is out of the plane 50.

A spring is an example of a springy element that can be used within the present invention for producing an idle state and a non-idle state. As mentioned above, a spring usually has two states: idle and non-idle state, wherein no power is applied to the spring. But the non-idle state has two sub-states: a state wherein the spring is elongated by a pulling power, and a state wherein the spring is shortened by a pushing power.

In the example illustrated in FIGS. 5 to 8 the power applied on the spring is for shortening the spring, however those skilled in the art will appreciate that the connection mechanism may designed to apply pulling power. Furthermore, an elastic object may be also employed for the springy element.

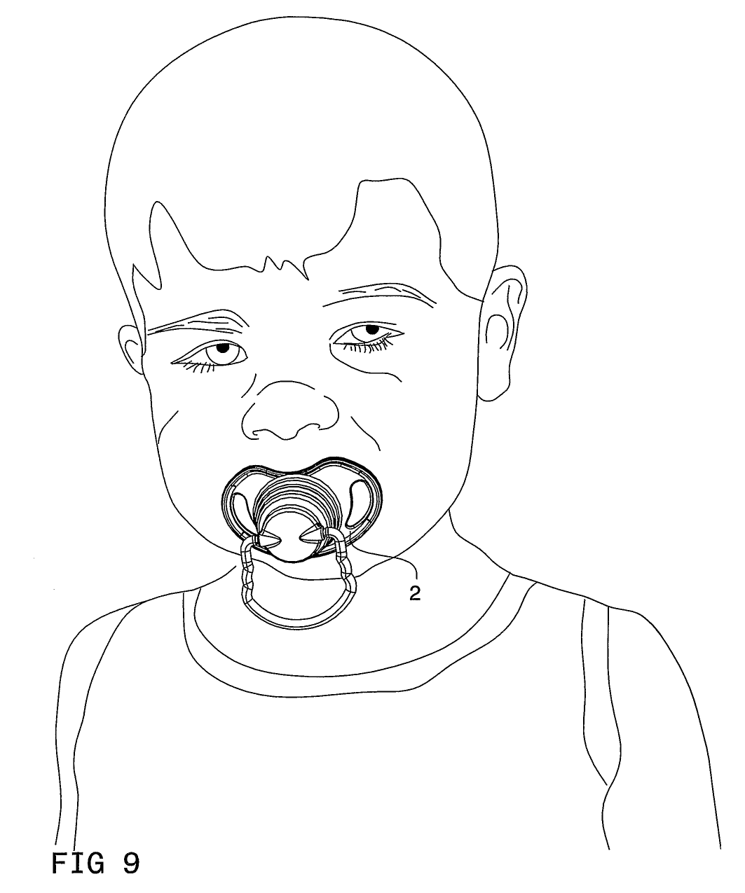

FIG. 9 illustrates an infant using the pacifier illustrated in FIGS. 1 to 4.

As illustrated, the cap does not necessarily have to be a closed form, but in contrary, an aperture 14 allows the saliva of the infant to be dispersed, thereby preventing creation of inflames at the infant's face.

The profile of the nipple of the pacifier may be circular as well as elongated.

In the specification and figures herein, the following elements are marked:

Numeral 2 denotes a pacifier; 6 denotes a bellows; 8 denotes a cap; 10 denotes a handle; 12 denotes a connection ring of the handle 12 to the bellows 6; 14 denotes a hollow in the cap 8; 16 denotes a nipple; 18 denotes a cylinder; 20 denotes a coupling; 22 denotes a ring for securing the bellows 6 to the cap 8; 24 denotes a ring for securing the nipple 16 to the coupling 20; 40 denotes a spring; 42 denotes a rod for pushing the nipple 16 from its idle state to its use state; 44 is a sliding plug which slides inside the cylinder 18; and 50 denotes a plane, such as the floor.

While certain features of the disclosure have been illustrated and described herein, the invention can be embodied in other forms, ways, modifications, substitutions, changes, equivalents, and so forth. The embodiments described herein should be considered as illustrative and not restrictive. It is, therefore, to be understood that the appended claims are intended to cover all such modifications and changes as fall within the true spirit of the disclosure.

What is claimed is:

1. A pacifier, comprising:
a nipple;
a protection cap; and
a connection mechanism, for connecting said nipple to said cap, said connection mechanism comprises a springy element wherein in the idle state of said springy mechanism said nipple is entirely protected by said cap from contact with a plane, and in the non-idle state thereof said nipple outstands from said plane, thereby enabling being used by an infant.

2. A pacifier according to claim 1, wherein said connection mechanism comprising:
a cylinder;
a sliding plug fitting closely inside the bore of said cylinder;
a spring keeping said plug secured to an opening of said cylinder, said nipple being connected to said plug.

3. A pacifier according to claim 1, wherein said springy element is based on a spring.

4. A pacifier according to claim 1, wherein said springy element is based on a bellows.

5. A pacifier according to claim 1, wherein said springy element is based on an elastic object.

6. A pacifier according to claim 1, wherein said cap having at least one aperture, for allowing the saliva of an infant to be dispersed.

7. A pacifier according to claim 1, wherein said nipple having an elongated profile.
